(19) United States
(12) Patent Application Publication
(10) Pub. No.: US 2016/0299642 A1
(43) Pub. Date: Oct. 13, 2016

(54) REDUCING A NUMBER OF SELECTABLE OPTIONS ON A DISPLAY

(71) Applicant: MICROSOFT TECHNOLOGY LICENSING, LLC., Redmond, WA (US)

(72) Inventors: Jonathan Esterly, Woodinville, WA (US); Amani Ahmed Dye, Bothell, WA (US)

(73) Assignee: MICROSOFT TECHNOLOGY LICENSING, LLC., Redmond, WA (US)

(21) Appl. No.: 14/684,885

(22) Filed: Apr. 13, 2015

(51) Int. Cl. G06F 3/0482; G06F 3/0488; G06F 3/0484

(52) U.S. Cl. CPC G06F 3/0482; G06F 3/04847; G06F 3/04842; G06F 3/0488

(57) ABSTRACT

Reducing a number of selectable options on a display is provided. An option selection engine generates a slider control on the display. The slider control includes a number of options. The option selection engine receives an input on the slider control for selecting one of the options. In response to the input received on the slider control, the option selection engine displays a variations group, selected from among multiple variations groupings, on the display. The displayed variations group is associated with the option selected from the slider control. Each of the multiple variations groupings is associated with a different option. The option selection engine receives a user selection of a variation from the previously displayed variations group. The option selection engine applies the received user selection to a displayed object.

### BACKGROUND

Application programs utilized by information workers/users provide large numbers of options that may be selected and subsequently applied to electronic documents. For example, an application program may provide multiple document themes that may be applied to an electronic document. In presenting the document themes to a user, the application program may simultaneously display a large number of different color themes, different multiple tints and shades associated with each color theme, as well as a number of standard colors.

It is with respect to these and other considerations that examples have been made. In addition, although relatively specific problems have been discussed, it should be understood that the examples should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects of the present disclosure are directed to reducing a number of selectable options to a user on a display. In one aspect, a computer system is provided that includes one or more processors and a memory which stores an option selection engine executable by the one or more processors. The option selection engine is utilized to generate a slider control on the display. The slider control includes a number of options. The option selection engine receives an input on the slider control for selecting one of the options. In response to the input received on the slider control, the option selection engine displays a group of variations selected from among multiple groupings of variations on the display. The displayed group of variations is associated with the option selected from the slider control. Each of the multiple groupings of variations is associated with a different option. The option selection engine receives a user selection of a variation from the previously displayed variations group. The option selection engine applies the received user selection to a displayed object.

Aspects of the present disclosure provide an application program which enables a computer to provide users the ability to select and refine from a large number of available options by utilizing a slider control to select and display a single option associated with a smaller subset of options based on the single option selected. Thus, aspects of the present disclosure reduce the size and number of items seen at once thereby conserving space on computing devices having a limited display size.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the present disclosure as claimed.

### BRIEF DESCRIPTION OF THE DRAWINGS

The accompanying drawings, which are incorporated in and constitute a part of this disclosure, illustrate various aspects of the present disclosure. In the drawings:

FIG. 1 is a simplified block diagram illustrating one system for reducing a number of selectable options on a display;

FIG. 2A illustrates an example of a user selecting an option from a slider control generated on a computing device;

FIG. 2B illustrates an example of a user selecting a variation from a group of variations associated with the previously selected option shown in FIG. 2A;

FIG. 3A illustrates another example of a user selecting an option from a slider control generated on a computing device;

FIG. 3B illustrates an example of a user selecting a variation from a group of variations associated with the previously selected option shown in FIG. 3A;

FIG. 4 is a simplified block diagram illustrating another system for reducing a number of selectable options on a display;

FIG. 5 illustrates an operational flow for reducing a number of selectable options on a display;

FIG. 6 is a block diagram illustrating example physical components of a computing device with which aspects of the present disclosure may be practiced;

FIGS. 7A and 7B are simplified block diagrams of a mobile computing device with which aspects of the present disclosure may be practiced; and

FIG. 8 is a simplified block diagram of a distributed computing system in which aspects of the present disclosure may be practiced.

### DETAILED DESCRIPTION

The following detailed description refers to the accompanying drawings. Wherever possible, the same reference numbers are used in the drawings and the following description to refers to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to reducing a number of selectable options on a display. In one aspect, a computer system is provided that includes one or more processors and a memory which stores an option selection engine executable by the one or more processors. The option selection engine is utilized to generate a slider control on the display. The slider control includes a number of options. The option selection engine receives an input on the slider control for selecting one of the options. In response to the input received on the slider control, the option selection engine displays a group of variations selected from among multiple groupings of variations on the display. The displayed group of variations is associated with the option selected from the slider control. Each of the multiple groupings of variations is associated with a different option. The option selection engine receives a user selection of a variation from the previously displayed variations group. The option selection engine applies the received user selection to a displayed object.

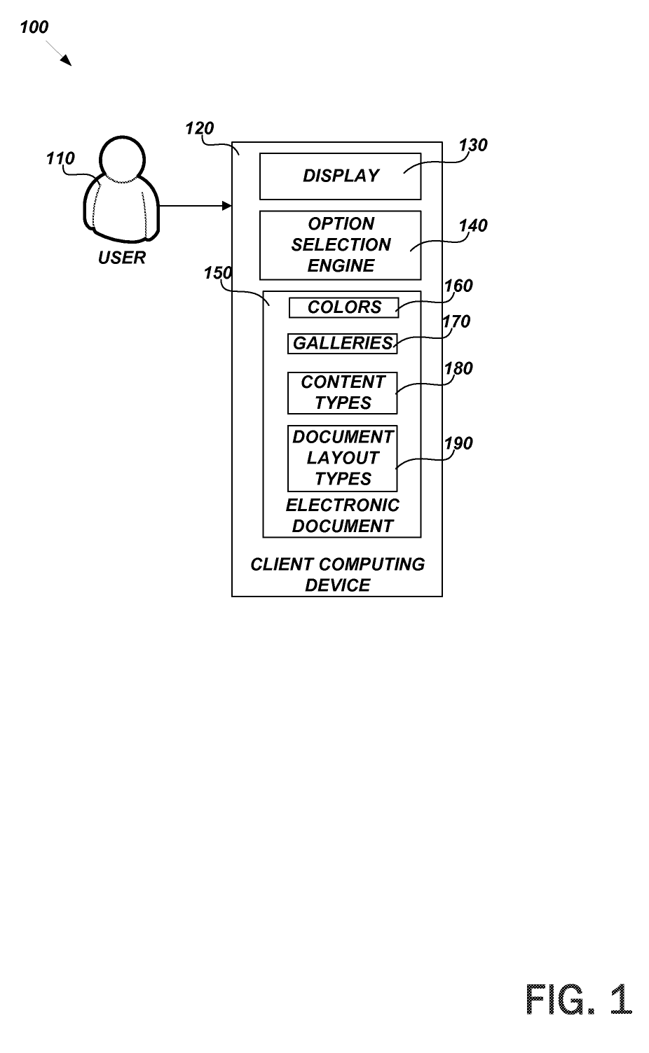

FIG. 1 is a simplified block diagram illustrating a system 100 for reducing a number of selectable options on a display. As illustrated in FIG. 1, a user 110 is in communication with a client computing device 120. The client computing device 120 may comprise any of a number of suitable computing devices such as a desktop computer, laptop computer, tablet-style computer, handheld computing device, mobile communication device, and the like. The client computing device 120 may include a display 130, an option selection engine 140, and one or more electronic documents 150. In an aspect, the display 130 may comprise a touchscreen display.

In an aspect, the option selection engine 140 may be a program module integrated within a productivity application program such as, for example, word processing software, presentation graphics software, spreadsheet software, diagramming software, project management software, publishing software and personal information management software. It should be appreciated that the aforementioned software applications may comprise individual application programs or alternatively, may be incorporated into a suite of applications such as the OFFICE application program suite from MICROSOFT CORPORATION of Redmond, Wash. Other applications programs from other manufacturers may also be utilized in accordance with the aspects disclosed herein. As will be described in greater detail below, the option selection engine 140 may be operable to reduce a number of selectable options on the display 130. According to an aspect, the user 110 may interact with the option selection engine 140 in order to select and apply one or more colors 160, galleries 170, content types 180 and document layout types 190 (as well as variations thereof) to the electronic document 150.

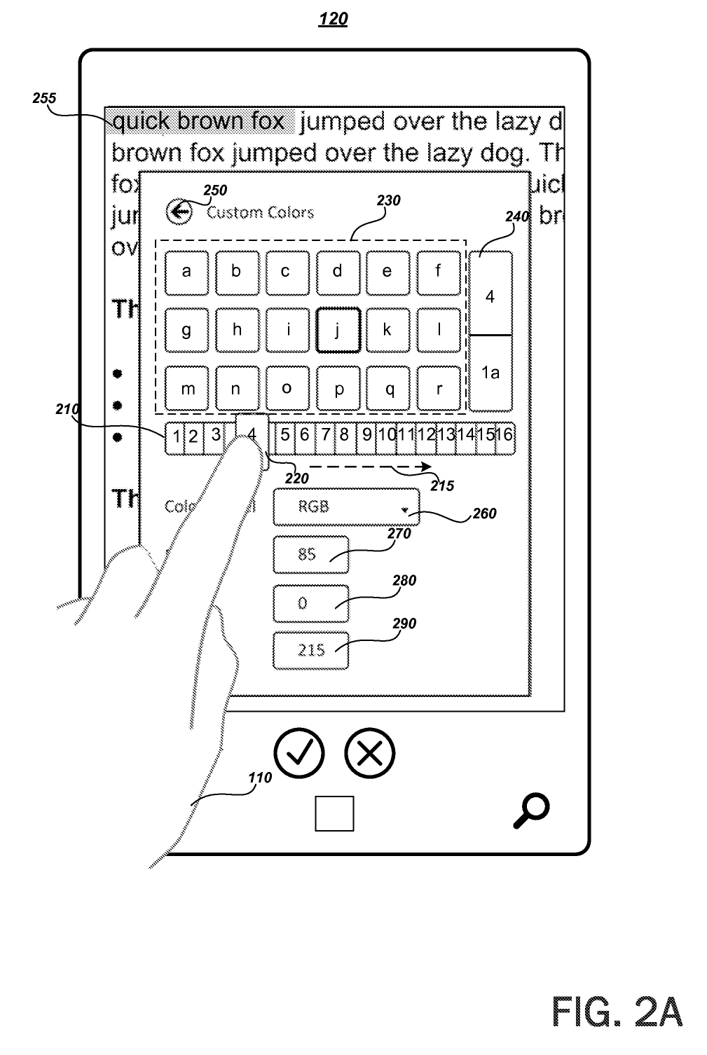

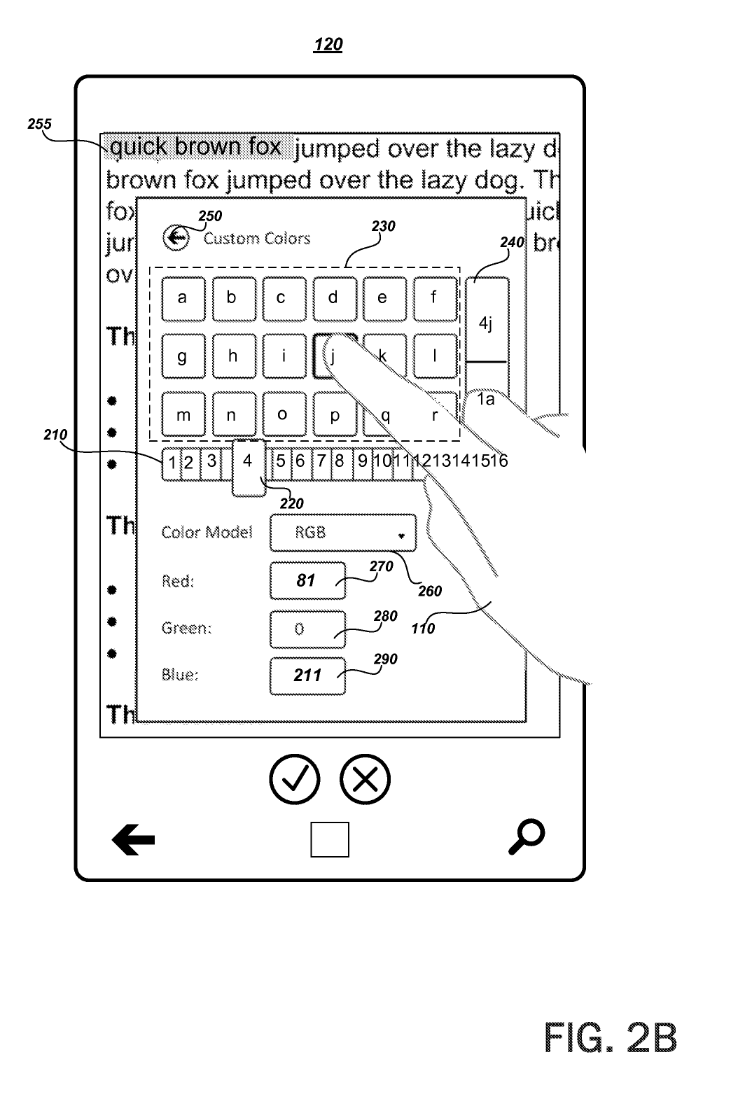

FIG. 2A illustrates an example of the user 110 selecting an option from a slider control 210 generated on the computing device 120. According to an aspect, the option selection engine 140 generates a user control (i.e., the slider control 210) over content in the electronic document 150 which is displayed on the display 130. The slider control 210 may include a number of options from which the user 110 may select for application to the electronic document 150. According to an aspect, each of the options on the slider control 210 (represented by the numbers 1-16) may represent different standard colors (e.g., red, green, blue, orange, yellow, white, black, etc.) that may be applied to an object 255 (e.g., highlighted text) in the electronic document 150. According to other aspects, the options on the slider control 210 may represent style galleries, document types and document layout types that may be applied to the electronic document 150.

According to an aspect, the user 110 may select an option via a touch input on the slider control 210. The touch input may be initiated by the user 110 either tapping an option on the slider control 210 (e.g., option 220) or, alternatively sliding across the slider control 210 (e.g., in the direction indicated by arrow 215) until a desired option is reached and then releasing a touch input from the slider control 210 to select the desired option. According to another aspect, a desired option may be selected when the user 110 releases or presses down on the slider control 210. It should be understood that in some aspects, the user 110 may alternatively select options using an input interface (e.g., a mouse). Once a desired option has been selected, the option selection engine 140 may be operable to apply an emphasis to the option 220 such that it is identifiable from among the other options on the slider control 210. For example, the display of the option 220 may be zoomed on the slider control 210 as shown in FIG. 2A. It should be appreciated that the option selection engine 140 may also apply other types of emphasis, such as highlighting, to the selected option 220 on the slider control 210.

The option selection control 140 may also generate a grid 230 and a preview element 240. According to an aspect, the option selection engine 140 may generate the grid 230 following the selection of the selected option 220 by the user 110 from the slider control 210. The grid 230 may include a group of variations or refinements which is associated with the option 220 previously selected from the slider control 210. It should be appreciated that there may a variations group (along with a corresponding grid) associated with each of the options shown on the slider control 210. According to an aspect, the group of variations in the grid 230 (represented by the letters a-r) may comprise a group of swatches (e.g., color swatches). Each of the swatches may represent different tints, shaded and/or saturations to vary (or refine) a selected standard color from the slider control 210. For example, if the option 220 selected from the slider control 210 is the color red, then each of the variations in the grid 230 would represent different tints, shades and/or saturations of the color red. According to other aspects, the variations in the grid 230 may represent refinements that may be applied to previously selected style galleries, document types or document layout types from the slider control 210. According to still other aspects, the variations in the grid 230 may be simultaneously updated in response to movement initiated by the user 110 (e.g., touch or mouse movement) across the slider control 210.

According to an aspect, the preview element 240 may simultaneously display a currently selected option (e.g., a new color) and a previously selected option (e.g., an old color) separated by a divider. For example, the preview element 240 shows the option 220 (e.g., option #4) and a previously selected option (e.g., option #1 as modified by variation “a”). According to an aspect, as the user 110 slides their finger across the slider control 210, the display of the current option in the preview element 240 will automatically change to correspond to the option that the user 110 is in contact with on the slider control 210. For example, if the slider control 210 contains selectable colors, then the color of the top half of the preview element 240 will change as the user 110 slides their finger across the slider control 210 until a desired color is selected.

The option selection engine 140 may also determine and display numerical data values corresponding to an option selected from the slider control 210. For example, if the option 220 is a combination of the colors red and blue, the option selection engine 140 will determine a corresponding color model 260 (e.g., RGB, Hex, HSL, etc.) as well numerical data values 270, 280 and 290 which correspond to the selected color. It should be appreciated that the aforementioned color model data values allow the user 110 to employ a finer grain control than what is allowed by the slider control 210 and the grid 230. According to an aspect, as the user 110 slides their finger across the slider control 210, the numerical data values 270-290 will automatically change to correspond to the option (e.g., color) that the user 110 is in contact with on the slider control 210. The option selection engine 140 may also generate an application button 250 to apply a selected option to an object (e.g., the highlighted text 255 in the electronic document 150). It should be understood that the aspects described herein are not limited to the display of the numerical data values 270-290. For example, according to some aspects, any controls that facilitate the further refinement of selected options (e.g., colors) from the slider control 210 (as well as from the grid 230) may also be shown.

FIG. 2B illustrates an example of the user 110 selecting a variation from a group of variations associated with the previously selected option 220 shown in FIG. 2A. According to an aspect, the user 110 may select a variation via a touch input on the grid 230. The touch input may be initiated by the user 110 either tapping a variation from within the grid 230 or, alternatively sliding across the grid 230 until a desired variation is reached and then releasing a touch input from the grid 230 to select the desired option. According to an aspect, as the user 110 slides their finger across the grid 230, the display of the current variation in the preview element 240 will automatically change to correspond to the variation that the user 110 is in contact with in the grid 230. For example, if the grid 230 contains variations comprising color swatches, then the colors in the top half of the preview element 240 will change as the user 110 slides their finger across the grid 230 until a desired variation is selected (i.e., the variation “4j”). Similarly, the numerical data values 270-290 will automatically change to correspond to the variation that the user 110 is in contact with within the grid 230. It should be understood that in some aspects, the user 110 may alternatively select variations on the grid 230 using an input interface (e.g., a mouse).

Once a desired variation has been selected, the option selection engine 140 may be operable to apply an emphasis to the selected variation that it is identifiable from among the other variations in the grid 230. For example, the selected variation “j” from the grid 230 may be distinguished from the other variations by highlighting the square surrounding the selected variation. After the desired variation has been selected, the variation may be applied to the object 255 in the electronic document 150 via the application button 250.

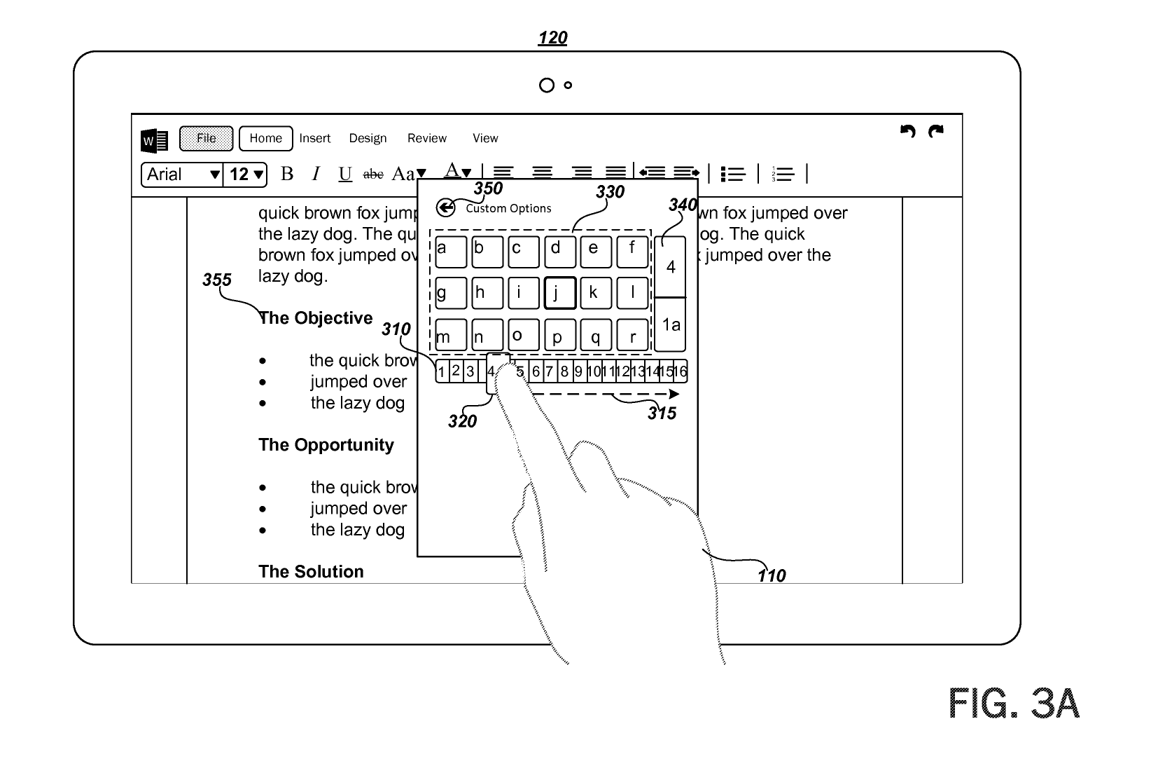

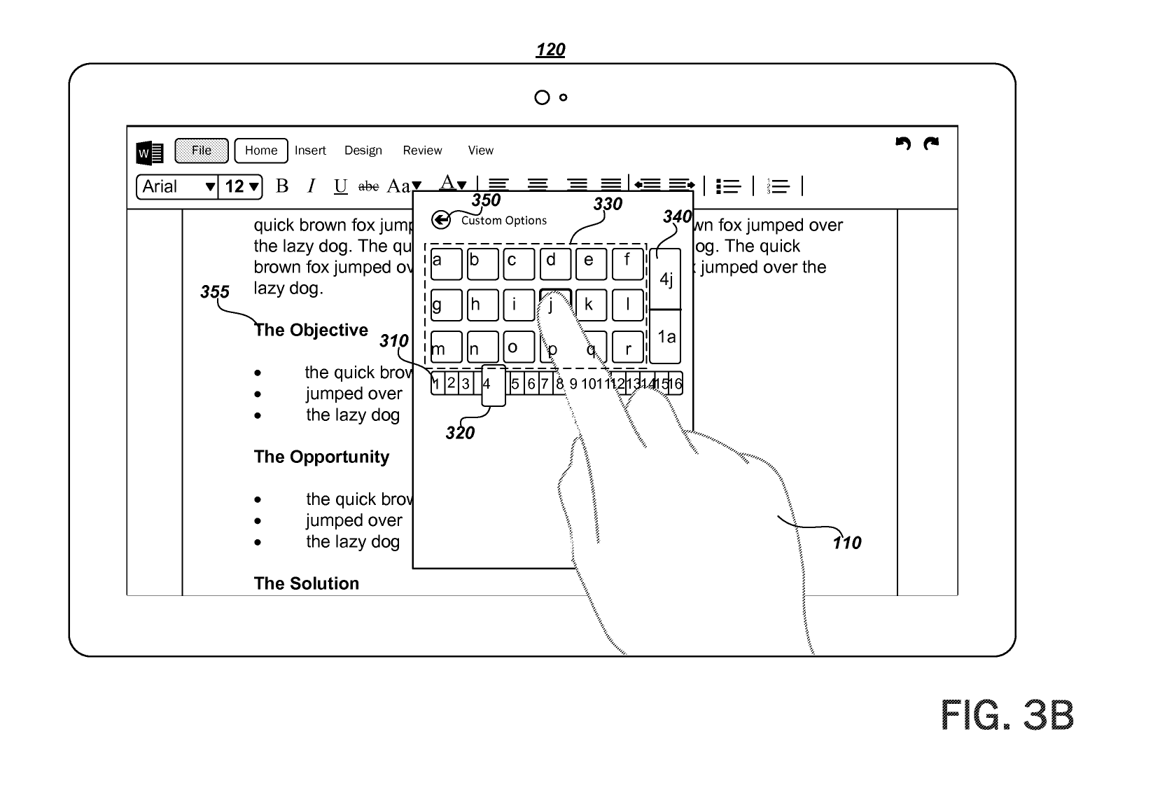

FIG. 3A illustrates another example of the user 110 selecting an option from a slider control 310 generated on the client computing device 120. According to an aspect, the option selection engine 140 generates a user control (i.e., the slider control 310) over content in the electronic document 150 which is displayed on the display 130. The slider control 310 may include a number of options from which the user 110 may select for application to the electronic document 150. According to an aspect, each of the options on the slider control 310 (represented by the numbers 1-16) may represent different document layouts or style galleries that may be applied to the electronic document 150.

According to an aspect, the user 110 may select an option via a touch input on the slider control 310. The touch input may be initiated by the user 110 either tapping an option on the slider control 310 (e.g., option 320) or, alternatively sliding across the slider control 210 (e.g., in the direction indicated by arrow 315) until a desired option is reached and then releasing a touch input from the slider control 310 to select the desired option. It should be understood that in some aspects, the user 110 may alternatively select options using an input interface (e.g., a mouse). Once a desired option has been selected, the option selection engine 140 may be operable to apply an emphasis to the option 320 such that it is identifiable from among the other options on the slider control 310. For example, the display of the option 320 may be zoomed on the slider control 310 as shown in FIG. 3A. It should be appreciated that the option selection engine 140 may also apply other types of emphasis, such as highlighting, to the selected option 320 on the slider control 310.

The option selection control 140 may also generate a grid 330 and a preview element 340. According to an aspect, the option selection engine 140 may generate the grid 330 following the selection of the selected option 320 by the user 110 from the slider control 310. The grid 330 may include a group of variations or refinements which is associated with the option 320 previously selected from the slider control 310. It should be appreciated that there may a variations group (along with a corresponding grid) associated with each of the options shown on the slider control 320. According to an aspect, the group of variations in the grid 330 (represented by the letters a-r) may comprise a group of refinements that may be applied to previously selected style galleries or document layout types, from the slider control 310.

According to an aspect, the preview element 340 may simultaneously display a currently selected option (e.g., a new document layout or style gallery) and a previously selected option (e.g., an old document layout or style gallery) separated by a divider. For example, the preview element 340 shows the option 320 (e.g., option #4) and a previously selected option (e.g., option #1 as modified by variation “a”). According to an aspect, as the user 110 slides their finger across the slider control 310, the display of the current option in the preview element 340 will automatically change to correspond to the option that the user 110 is in contact with on the slider control 310. The option selection engine 140 may also generate an application button 350 to apply a selected option to an object (e.g., the text 355 in the electronic document 150).

FIG. 3B illustrates an example of the user 110 selecting a variation from a group of variations associated with the previously selected option 320 shown in FIG. 3A. According to an aspect, the user 110 may select a variation via a touch input on the grid 330. The touch input may be initiated by the user 110 either tapping a variation from within the grid 330 or, alternatively sliding across the grid 330 until a desired variation is reached and then releasing a touch input from the grid 330 to select the desired option. According to an aspect, as the user 110 slides their finger across the grid 330, the display of the current variation in the preview element 340 will automatically change to correspond to the variation that the user 110 is in contact with in the grid 330. For example, if the grid 230 contains variations associated with document layouts or style galleries), then the display for the top half of the preview element 340 will change as the user 110 slides their finger across the grid 330 until a desired variation is selected (i.e., the variation “4j”). It should be understood that in some aspects, the touch interactions described above may alternatively be performed using an input interface (e.g., a mouse).

Once a desired variation has been selected, the option selection engine 140 may be operable to apply an emphasis to the selected variation that it is identifiable from among the other variations in the grid 330. For example, the selected variation “j” from the grid 330 may be distinguished from the other variations by highlighting the square surrounding the selected variation. After the desired variation has been selected, the variation may be applied to the object 355 in the electronic document 150 via the application button 350.

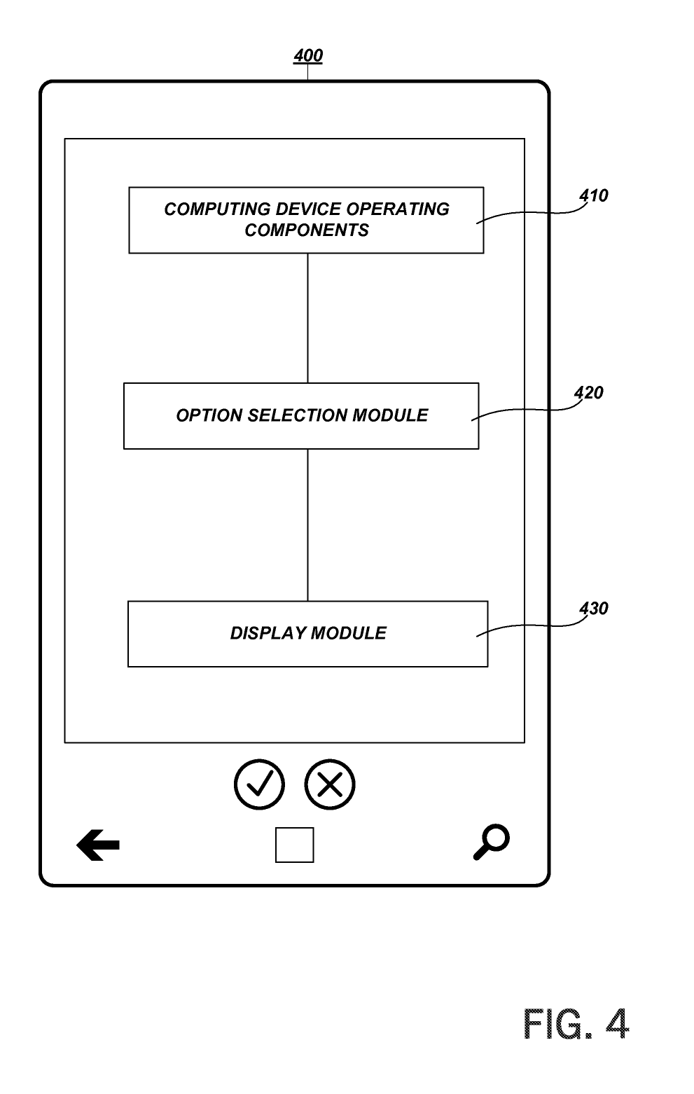

FIG. 4 is a simplified block diagram illustrating another system 400 for reducing a number of selectable options on the display 130. The system 400, which may include a computing device, includes computing device operating components 410 (e.g., one or more processors and a memory store) in communication with an option selection module 420. The option selection module 420 may be in communication with the computing device operating components 410 and also in communication with a display module 430. According to an aspect, the options selection module 420 may be executed by the one or more processors in the computing device operating components 410 and operable to generate a slider control for display on the system 400 by the display module 430. The slider control includes a number of options. The option selection module 410 may further receive an input on the slider control for selecting one of the options. In response to the input received on the slider control, the option selection module 430 may communicate with the display module 430 to display a variations group, selected from among multiple variations groupings, on the system 400. The displayed variations group is associated with the option selected from the slider control. Each of the multiple variations groupings is associated with a different option. The option selection module 420 may receive a user selection of a variation from the previously displayed variations group via the display module 430. The option selection module 420 may then apply the received user selection to a displayed object via the display module 430.

Having described an operating environment and various aspects of aspects of the present disclosure with respect to FIGS. 1-4, FIG. 5 is a flow chart illustrating a method for reducing a number of selectable options on the display 120. The routine 500 begins at start OPERATION 505 and proceeds to OPERATION 510, where the option selection engine 140 executing on a computer (i.e., the client computing device 120) may generate a user control that includes a number of options, on the display 130. In an aspect, the user control may be the slider control 210 or 310 discussed above with respect to FIGS. 2-3.

At OPERATION 515, the option selection engine 140 may receive an input on the user control for selecting one of the options thereon. According to an aspect, the input may be a touch or other input (e.g., mouse) across the user control to select one of the number of options. According to various aspects, the options may include colors, document style galleries, content types and document layout types. According to another aspect, the option selection engine 140 may also determine one or more numerical data values corresponding to each of the options on the user control in response to the received input. The option selection engine 140 may further display the one or more numerical data values on the display 130.

At OPERATION 520, the option selection engine 140 may display a group of variations selected from among multiple variations groups. The displayed group of variations may be associated with the option selected at OPERATION 515 from the user control. Each of the variations groups may be associated with a different option on the user control. Each of the variations groups comprise a grid. The grid may include a number of refinements based on the selected option from the user control. According to an aspect, the refinements may be color swatches and the options on the user control may be different colors.

At OPERATION 525, the option selection engine 140 may receive a selection of a variation from the displayed group of variations. According to an aspect, the option selection engine may also display a preview element adjacent to the displayed group of variations. The preview element may show a variation previously applied to the displayed object and the currently selected variation. According to another aspect, the option selection engine 140 may update the display of the previously determined numerical data values (see OPERATION 515) based on the selected variation.

At OPERATION 530, the option selection engine 140 may apply the received variation selection to a displayed object on the display 130. The method 500 ends at OPERATION 595.

While the present disclosure has been described in the general context of program modules that execute in conjunction with an application program that runs on an operating system on a computer, those skilled in the art will recognize that the present disclosure may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which aspects of the present disclosure are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

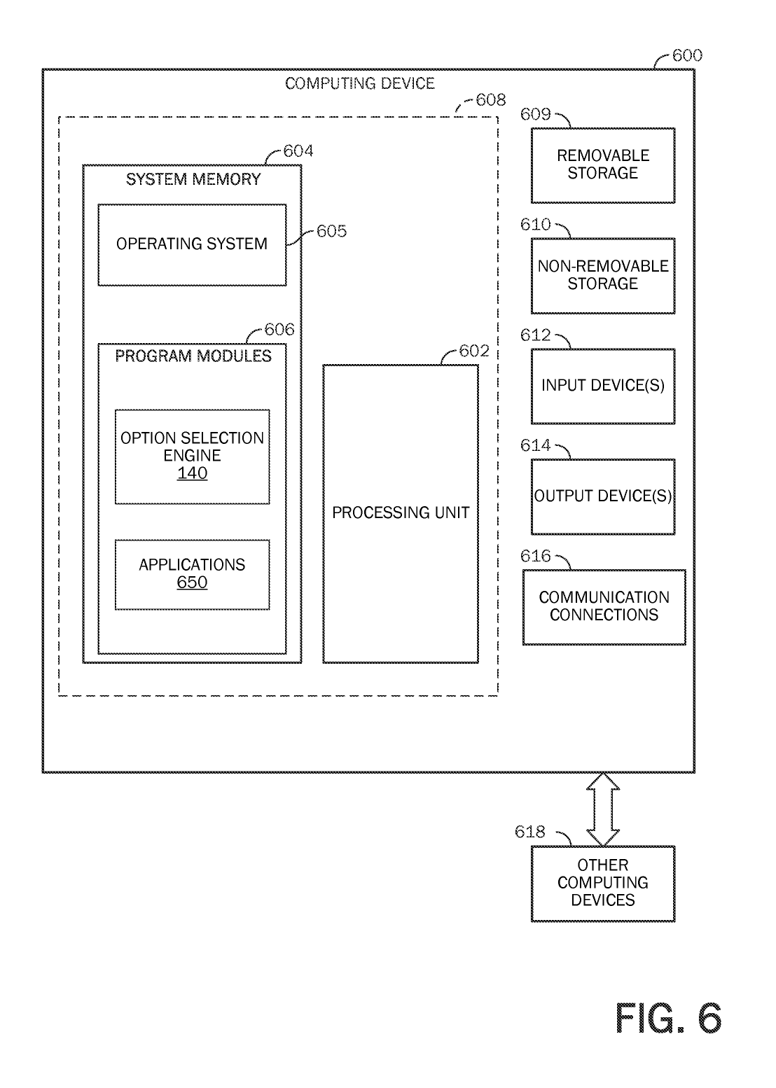

FIG. 6-8 and the associated descriptions provide a discussion of a variety of operating environments in which examples of the present disclosure are practiced. However, the devices and systems illustrated and discussed with respect to FIGS. 6-8 are for purposes of example and illustration and are not limiting of a vast number of computing device configurations that are utilized for practicing aspects of the present disclosure, described herein.

FIG. 6 is a block diagram illustrating physical components (i.e., hardware) of a computing device 600 with which examples of the present disclosure are be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more programming modules 606 suitable for running software applications 650. According to an aspect, the system memory 604 includes the option selection engine 140 and the applications 650. The operating system 605, for example, is suitable for controlling the operation of the computing device 600. Furthermore, aspects of the present disclosure are practiced in conjunction with a graphics library, other operating systems, or any other application program and, thus is not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

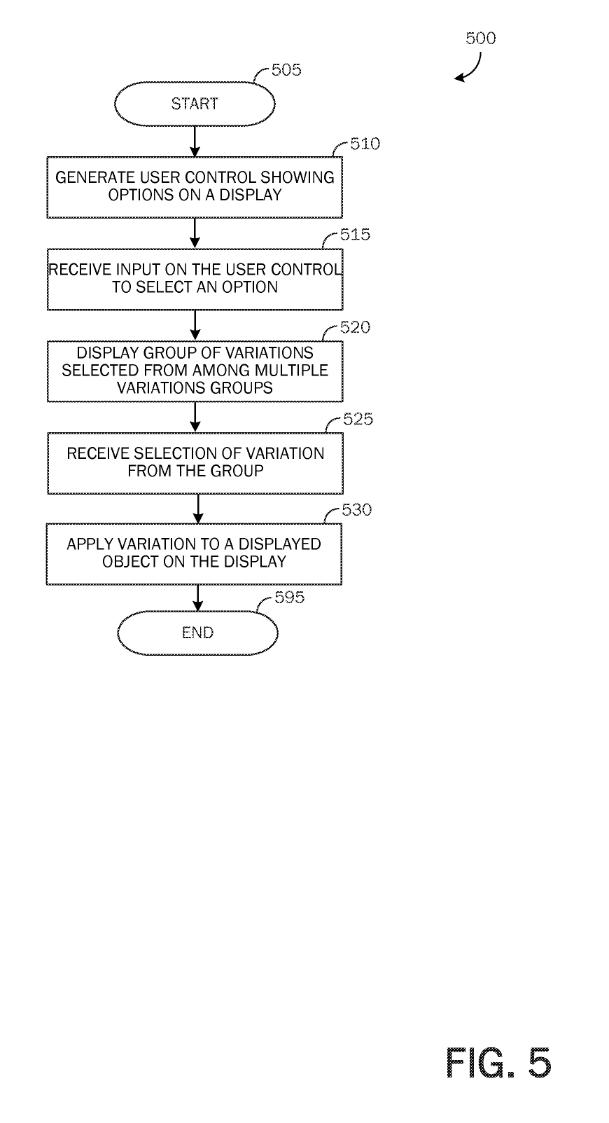

As stated above, according to an aspect, a number of program modules and data files are stored in the system memory 604. While executing on the processing unit 602, the program modules 606 (e.g., the option selection engine 140) perform processes including, but not limited to, one or more of the stages of the method 500 illustrated in FIG. 5. According to an aspect, other program modules are used in accordance with examples of the present disclosure and include applications such as electronic mail and contacts applications, word processing applications, spreadsheet applications, database applications, slide presentation applications, drawing or computer-aided application programs, etc.

According to an aspect, aspects of the present disclosure are practiced in an electrical circuit comprising discrete electronic elements, packaged or integrated electronic chips containing logic gates, a circuit utilizing a microprocessor, or on a single chip containing electronic elements or microprocessors. For example, aspects of the present disclosure are practiced via a system-on-a-chip (SOC) where each or many of the components illustrated in FIG. 6 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 600 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects of the present disclosure are practiced within a general purpose computer or in any other circuits or systems.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

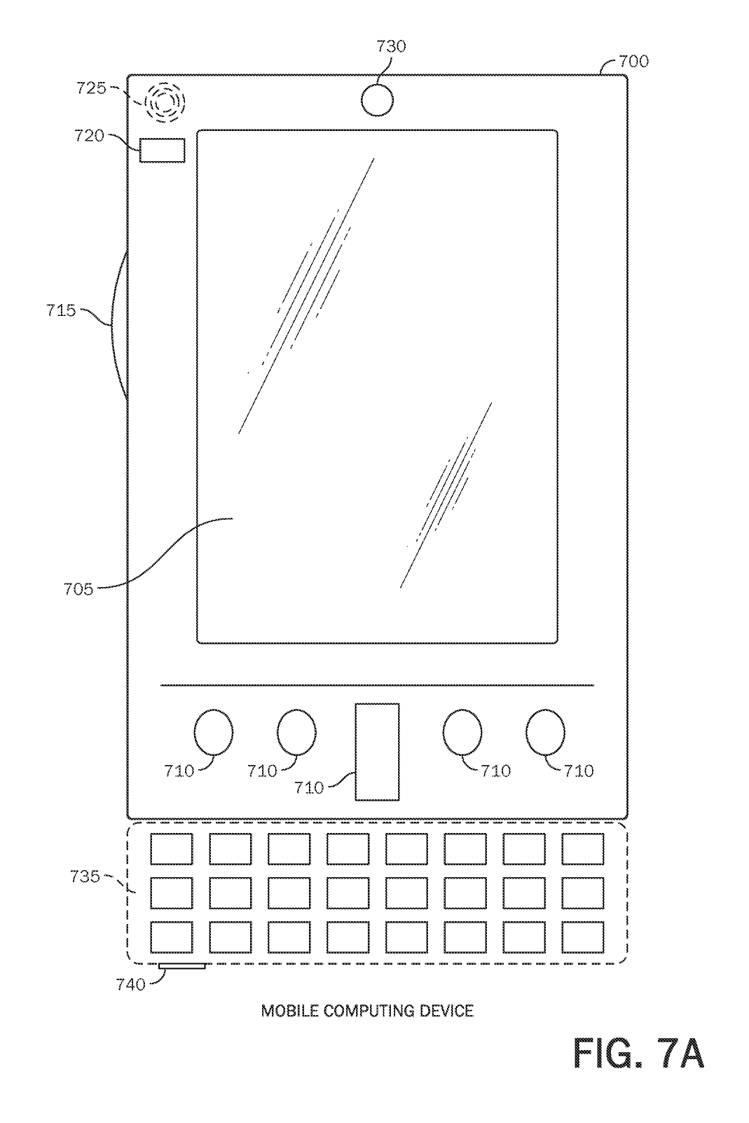

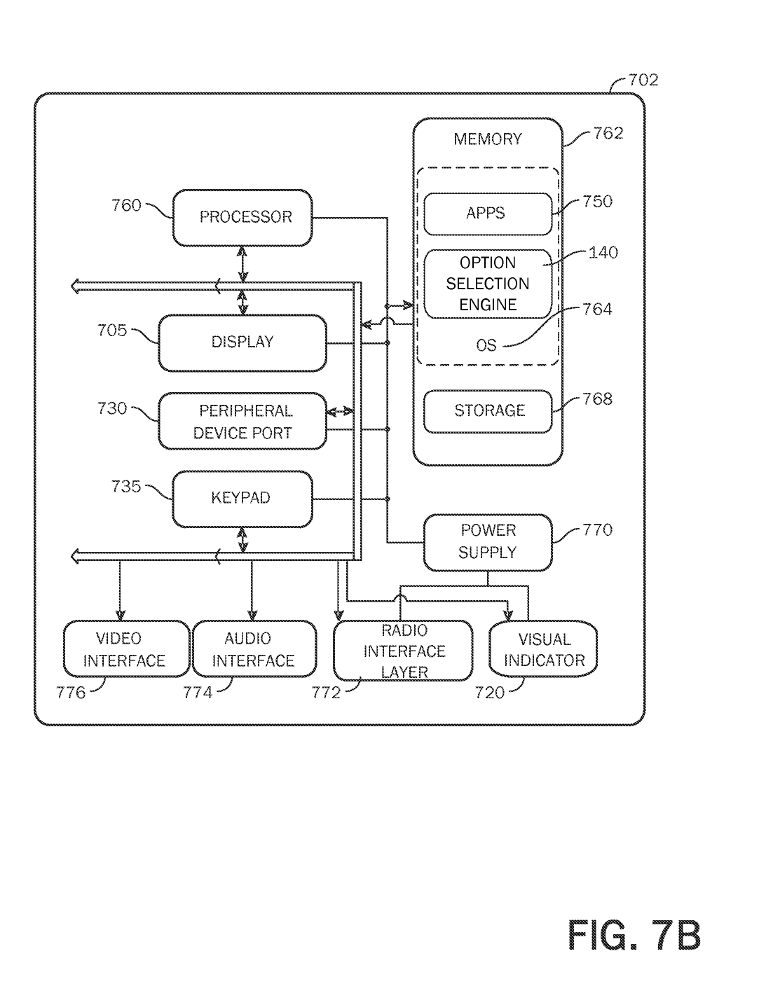

FIGS. 7A and 7B illustrate a mobile computing device 700, for example, a mobile telephone, a smart phone, a tablet personal computer, a laptop computer, and the like, with which aspects of the present disclosure may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or less input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 700 incorporates peripheral device port 740, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, the option selection engine 140 is loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 is stored locally on the mobile computing device 700, as described above. According to another aspect, the data is stored on any number of storage media that is accessible by the device via the radio 772 or via a wired connection between the mobile computing device 700 and a separate computing device associated with the mobile computing device 700, for example, a server computer in a distributed computing network, such as the Internet. As should be appreciated such data/information is accessible via the mobile computing device 700 via the radio 772 or via a distributed computing network. Similarly, according to an aspect, such data/information is readily transferred between computing devices for storage and use according to well-known data/information transfer and storage means, including electronic mail and collaborative data/information sharing systems.

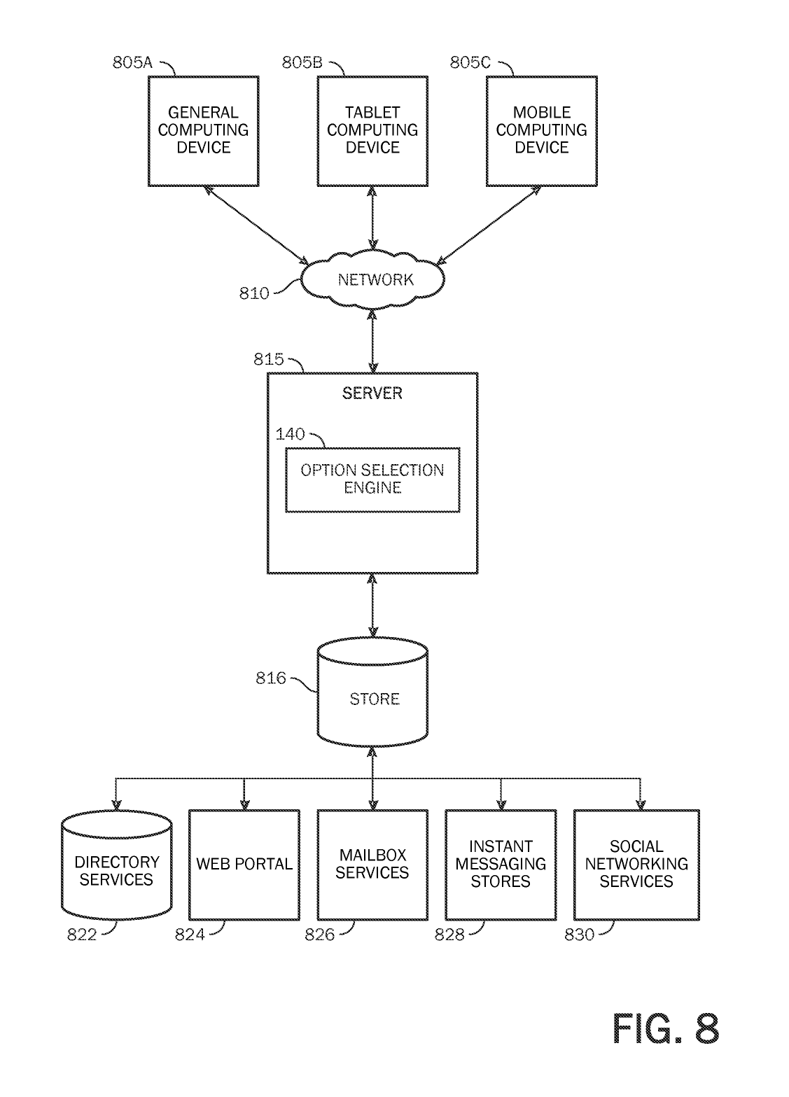

FIG. 8 illustrates one example of the architecture of a system for reducing a number of selectable options on a display 130 as described above. Content developed, interacted with, or edited in association with the option selection 140 is enabled to be stored in different communication channels or other storage types. For example, various documents may be stored using a directory service 822, a web portal 824, a mailbox service 826, an instant messaging store 828, or a social networking site 830. The option selection engine 140 is operable to use any of these types of systems or the like for reducing a number of selectable options on a display 130, as described herein. According to an aspect, a server 815 provides the option selection engine 140 to clients 805A-C. As one example, the server 815 is a web server providing the option selection engine 140 over the web. The server 815 provides the option selection engine 140 over the web to clients 805 through a network 810. By way of example, the client computing device is implemented and embodied in a personal computer 805A, a tablet computing device 805B or a mobile computing device 805C (e.g., a smart phone), or other computing device. Any of these examples of the client computing device are operable to obtain content from the store 816.

Various aspects described herein are directed to reducing a number of selectable options on a display. In one aspect, a computer system is provided that includes one or more processors and a memory which stores an option selection engine executable by the one or more processors. The option selection engine is utilized to generate a slider control on the display. The slider control includes a number of options. Each of the options may correspond to a different color that may be applied to the displayed object. Each of the options may alternatively correspond to different document style galleries, document content types and a document layout types. The option selection engine receives an input on the slider control for selecting one of the options. The input on the slider control may be a touch input received across the options included on the slider control. In response to the input received on the slider control, the option selection engine displays a group of variations selected from among multiple groupings of variations on the display. The displayed group of variations is associated with the option selected from the slider control. Each of the multiple groupings of variations is associated with a different option. Each variations grouping may include a grid or grouping of tints and shades for a color displayed as an option on the slider control. The option selection engine receives a user selection of a variation from the previously displayed variations group. The option selection engine applies the received user selection to a displayed object.

With respect to the current aspect, the option selection engine may be further operable to display a preview element adjacent to the displayed variations group. The preview element shows a variation previously applied to the displayed object and the currently selected variation. The option selection engine may be further operable to: (1) determine numerical data values corresponding to each of the options in response to the input received on the slider control; and (2) display the numerical data values. The option selection engine may be further operable to update the numerical data values based on the selected variation. The numerical data values may be numerical color values associated with a color model (e.g., an RGB color model).

In another aspect, a computer-implemented method is provided for reducing a number of selectable options on a display. The method includes generating, by the computer, a user control comprising multiple options on the display. The multiple options may represent different colors or document style galleries or document content types or document layout types. The method further includes receiving an input on the user control for selecting one of the multiple options. Responsive to the input received on the user control, the method further includes displaying a group of variations selected from among multiple groups of variations. The group of variations is displayed as a grid that includes a number of refinements based on the selected option. The grid may include a number of color swatches based on the selected option. The displayed group of variations is associated with the previously selected option. Each of the multiple groups of variations is associated with a different option. The method further includes receiving a selection of a variation from the group of variations and applying the received selection to a displayed object.

Aspects of the present disclosure, for example, are described above with reference to block diagrams and/or operational illustrations of methods, systems, and computer program products according to aspects of the present disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope of the present disclosure as claimed in any way. The aspects, examples, and details provided in this application are considered sufficient to convey possession and enable others to make and use the best mode of the present disclosure. The present disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A system for reducing a number of selectable options on a display, comprising:
one or more processors;
a memory storing one or more engines executable by the one or more processors, the one or more engines comprising:
an option selection engine operable to:
generate a slider control comprising a plurality of options on display;
receive an input on the slider control for selecting one of the plurality of options;
responsive to the input received on the slider control, display a group of variations selected from among a plurality of groups of variations, the displayed group of variations being associated with the selected one of the plurality of options, each of the plurality of groups of variations being associated with a different one of the plurality of options;
receive a selection of a variation from the displayed group of variations; and
apply the received selection to a displayed object.

2. The system of claim 1, wherein the option selection engine is further operable to display a preview element adjacent to the displayed group of variations, the preview element showing a variation previously applied to the displayed object and the currently selected variation.

3. The system of claim 1, wherein the option selection engine is further operable to:
determine one or more numerical data values corresponding to each of the plurality of options in response to the input received on the slider control; and
display the one or more numerical data values.

4. The system of claim 3, wherein the option selection engine is further operable to update the one or more numerical data values based on the selected variation.

5. The system of claim 1, wherein the input on the slider control is received in response to a touch input received across the plurality of options.

6. The system of claim 1, wherein the plurality of options comprises a plurality of different colors for application to the displayed object.

7. The system of claim 6, wherein the group of variations comprises a group of tints and shades based on a selected color from among the plurality of different colors.

8. The system of claim 1, wherein the plurality of options comprises one or more of a plurality of different document style galleries, a plurality of content types and a plurality of document layout types.

9. A computer-implemented method for reducing a number of selectable options on a display, comprising:
generating, by the computer, a user control comprising a plurality of options on the display;
receiving an input on the user control for selecting one of the plurality of options;
responsive to the input received on the user control, displaying a group of variations selected from among a plurality of groups of variations, the displayed group of variations being associated with the selected one of the plurality of options, each of the plurality of groups of variations being associated with a different one of the plurality of options;
receiving a selection of a variation from the group of variations; and
applying the received selection to a displayed object.

10. The method of claim 9, further comprising displaying a preview element adjacent to the displayed group of variations, the preview element showing a variation previously applied to the displayed object and the currently selected variation.

11. The method of claim 9, further comprising:
determining one or more numerical data values corresponding to each of the plurality of options in response to the input received on the user control; and
displaying the one or more numerical data values.

12. The method of claim 11, further comprising updating the one or more numerical data values based on the selected variation.

13. The method of claim 9, wherein receiving the input on the user control comprises receiving a touch input across the user control to select one of the plurality of different options.

14. The method of claim 9, wherein displaying the group of variations comprises displaying a grid comprising a plurality of refinements based on the selected one of the plurality of options.

15. The method of claim 14, wherein displaying the grid comprises displaying a plurality of color swatches based on the selected one of the plurality of options, the plurality of options comprising a plurality of different colors.

16. The method of claim 9, wherein receiving an input on the user control for selecting one of the plurality of options comprises receiving an input to select one or more of a plurality of different colors, a plurality of document style galleries, a plurality of content types and a plurality of document layout types.

17. A system for reducing a number of selectable options on a display, comprising:
one or more processors;
a memory storing one or more engines executable by the one or more processors, the one or more engines comprising:
an option selection engine operable to:
generate a slider control comprising a plurality of colors on the display;
receive an input on the slider control for selecting one of the plurality of colors;
display a grid comprising a plurality of color swatches, the grid being selected from among a plurality of grids, the plurality of color swatches comprising tints and shades corresponding to the selected one of the plurality of colors, each of the plurality of grids being associated with a different one of the plurality of colors;
receive a selection of one of the plurality of color swatches from the grid; and
apply the received selection of the one of the plurality of color swatches to an electronic document on the display.

18. The system of claim 17, wherein the option selection engine is further operable to display a preview element adjacent to the grid, the preview control showing a color swatch previously applied to the electronic document on the display and the currently selected one of the plurality of color swatches.

19. The system of claim 17, wherein the option selection engine is further operable to display one or more numerical data values corresponding to each of the plurality of colors in response to the input received on the slider control.

20. The system of claim 19, wherein the option selection engine is further operable to update the one or more numerical data values based on the selected one of the plurality of color swatches.
